(19) United States
(12) Patent Application Publication
(10) Pub. No.: US 2008/0286657 A1
(43) Pub. Date: Nov. 20, 2008

(54) NON-AQUEOUS ELECTROLYTE SECONDARY BATTERY

(75) Inventors: Kazuhiro HASEGAWA, Osaka (JP); Akihiro SUZUKI, Osaka (JP); Hiroyuki FUJIMOTO, Osaka (JP); Katsuaki TAKAHASHI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/121,214

(22) Filed: May 15, 2008

(30) Foreign Application Priority Data
May 16, 2007 (JP) 2007-129938
Feb. 14, 2008 (JP) 2008-032504

(51) Int. Cl. H01M 10/26; H01M 4/58

(52) U.S. Cl. 429/338; 429/231.8

(57) ABSTRACT

A non-aqueous electrolyte secondary battery is composed of a positive electrode containing a positive electrode active material capable of storing and releasing lithium ion, a negative electrode containing a negative electrode active material capable of storing and releasing lithium ion, and a non-aqueous electrolyte. The negative electrode active material contains a first material of a graphite material and a second material of a complex in which graphite material and silicon or silicon composite are coated with amorphous carbon material, and a cyclic carbonic acid ester derivative having fluoride atom and a sulfur-containing composite having cyclic structure are added to the non-aqueous electrolyte.

### RELATED APPLICATIONS

This application claims priority from Japanese Patent Application Nos. 2007-129938 and 2008-32504, which are hereby incorporated by reference.

### BACKGROUND OF THE INVENTION

1. Field of the Invention

The present invention relates to non-aqueous electrolyte secondary batteries employing positive electrodes containing positive electrode active materials capable of storing and releasing lithium, negative electrodes and non-aqueous electrolytes. More particularly, a feature of the invention is an improvement in a negative electrode active material and a non-aqueous electrolyte, which utilizes, for the purpose of increasing battery capacity and improving charge-discharge cycle characteristics, whereby a battery expansion in the case of preservation in charging condition under high temperature environments is restricted.

2. Description of Related Art

In recent years, a non-aqueous electrolyte secondary battery employing a non-aqueous electrolyte wherein lithium ion is moved between a positive electrode and a negative electrode to perform charging/discharging has been widely used as a power source of mobile electronic devices and a power supply for electric power storage.

This type of non-aqueous electrolyte secondary battery has been usually utilized a graphite material as a negative electrode active material in its negative electrode.

When the graphite material is used, the non-aqueous electrolyte secondary battery has a flat discharge potential, and charging/discharging is performed by insertion or de-insertion of lithium ion among crystal layers of the graphite material, which prevents precipitation of acicular metal lithium. As a result, the graphite material is advantageous to obtain the non-aqueous electrolyte secondary battery with small variation of volume.

In recent years, a non-aqueous electrolyte secondary battery has been demanded to have higher capacity to be used for multi-functioned higher performance mobile electronic devices. However, in the case where the foregoing graphite material is used, because theoretical capacity of intercalation compound LiC₆ is 372 mAh/g and small, it has been difficult to meet the above described demands.

Therefore, in recent years, as a negative electrode active material with high capacity, using materials such as, silicon, tin, and aluminum has been investigated. Particularly, because silicon has a large theoretical capacity per unit, about 4200 mAh/g, a variety of investigation has been conducted for its practical use.

However, materials such as silicon forming an alloy with lithium, have great variation of volume with storage and release of lithium, which deteriorates charge-discharge cycle characteristics of a non-aqueous electrolyte secondary battery.

Therefore, it has been proposed as shown in JP-A 2003-263986 to use carbonaceous materials in which silicon is carried on the surface of carbon particle and the surface of carbon particle is coated with carbon material for absorbing variation of volume by the carbon particle in order to improve charge-discharge cycle characteristics of a non-aqueous electrolyte secondary battery.

However, in the case where carbonaceous materials in which silicon is carried on the surface of carbon particle and in which the surface of carbon particle is coated with carbon material are used, a reaction occurs between the non-aqueous electrolyte and the negative electrode active material, causing a decomposition of the non-aqueous electrolyte during charging/discharging. Further, volume of silicon is varied during repeated charge-discharge cycling and battery capacity is gradually decreased.

Still further, in the case where only such carbonaceous materials are used, filing density of the negative electrode active material is decreased and sufficient capacity is hardly attained, and initial charge-discharge efficiency is lower than the case where graphite materials are used.

Also, in recent years, as shown in JP-A 2005-228565, there has been disclosed the addition of carbonic acid ester derivative having halide atom such as 4-fluoroethylene carbonate to a non-aqueous electrolyte for the purpose of suppressing decomposition of the non-aqueous electrolyte resulting from reaction between a negative electrode active material such as silicon forming an alloy with lithium ion during charging/discharging.

Nevertheless, in the non-aqueous electrolyte secondary battery using carbonaceous materials in which silicon is carried on the surface of carbon particle and the surface of carbon particle is coated with carbon material, if the non-aqueous electrolyte containing carbonic acid ester derivative having halide atom such as 4-fluoroethylene carbonate is used, in the case of preservation of the non-aqueous electrolyte secondary battery in charging condition under high temperature environments, the reaction between aforesaid carbonic acid ester derivative having halide atom and aforesaid carbonaceous materials occurs and the decomposition of the carbonic acid ester derivative having halide atom is caused, as a result, a problem of battery expansion has still remained.

### SUMMARY OF THE INVENTION

It is an object of the present invention to improve a negative electrode active material and a non-aqueous electrolyte so that a non-aqueous electrolyte secondary battery having excellent charge-discharge cycle characteristics with high capacity can be obtained and to suppress expansion of the non-aqueous electrolyte secondary battery in the case of preservation in charging condition under high temperature environments.

The present invention provides a non-aqueous electrolyte secondary battery comprising a positive electrode containing a positive electrode active material capable of storing and releasing lithium ion, a negative electrode containing a negative electrode active material capable of storing and releasing lithium ion, and a non-aqueous electrolyte, the negative electrode active material comprises a first material of a graphite material and a second material of a complex in which graphite material and silicon or silicon composite are coated with amorphous carbon material, and cyclic carbonic acid ester derivative having fluoride atom and sulfur-containing composite having cyclic structure are added to the non-aqueous electrolyte.

The non-aqueous electrolyte secondary battery of the present invention uses the negative electrode active material comprising the first material of the graphite material and the second material of the complex in which graphite material and silicon or silicon composite are coated with amorphous carbon material.

As a consequence, because of the first material of graphite material, filling density of the negative electrode active material is improved compared with the case of using only the second material of the complex in which graphite material and silicon or silicon composite are coated with amorphous carbon material, and sufficient battery capacity is attained and initial charge-discharge efficiency is enhanced.

Also, with the non-aqueous electrolyte secondary battery of the present invention wherein the cyclic carbonic acid ester derivative having fluoride atom and the sulfur-containing composite having cyclic structure are added to the non-aqueous electrolyte, because of the cyclic carbonic acid ester derivative having fluoride atom, a stable film is formed on the surface of the negative electrode active material during charging/discharging. As a result, decomposition of the non-aqueous electrolyte resulting from reaction between the negative electrode active material during charging/discharging is suppressed and a non-aqueous electrolyte secondary battery having improved charge-discharge cycle characteristics can be obtained.

If the sulfur-containing composite having cyclic structure is added to the non-aqueous electrolyte as described above, in the case where the non-aqueous electrolyte secondary battery is preserved in charging condition under high temperature environments, decomposition of the cyclic carbonic acid ester derivative having fluoride atom resulting from reaction between the negative electrode active material is suppressed and battery expansion is prevented.

In the case where the non-aqueous electrolyte secondary battery is preserved in charging condition under high temperature environments, although the reason why the reaction between the cyclic carbonic acid ester derivative having fluoride atom and the negative electrode active material is suppressed is not fully understood, it is believed that the sulfur-containing composite having cyclic structure is decomposed, so that a stable protection film is formed on the surface of the first material of the graphite material and the second material of the complex in which graphite material and silicon or silicon composite are coated with amorphous carbon material.

These and other objects, advantages and features of the invention will become apparent from the following description thereof taken in conjunction with the accompanying drawings which illustrate specific embodiments of the invention.

### BRIEF DESCRIPTION OF THE DRAWINGS

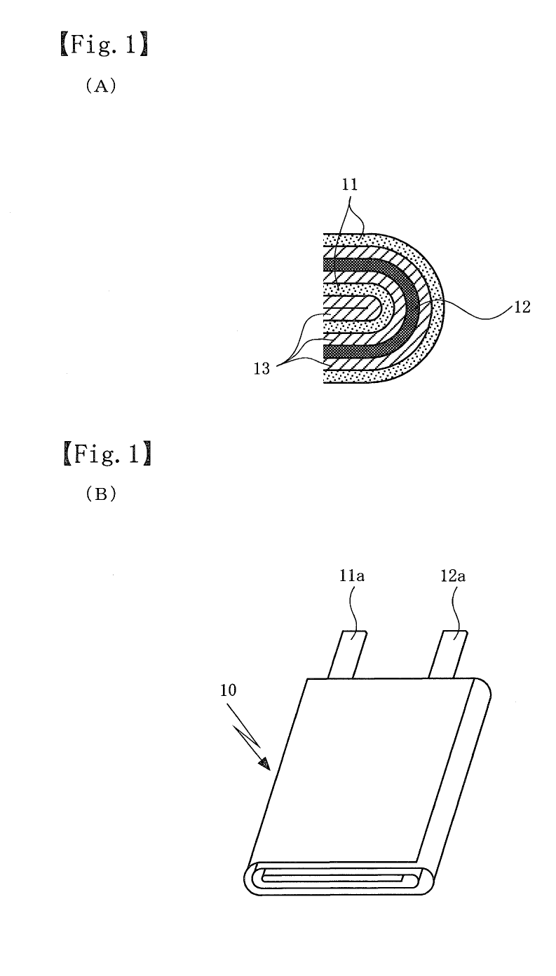

The FIG. 1 is a partial cross-sectional view and a schematic perspective view illustrating a flat electrode fabricated for Examples 1 to 5 and Comparative Examples 1 to 5 of the present invention.

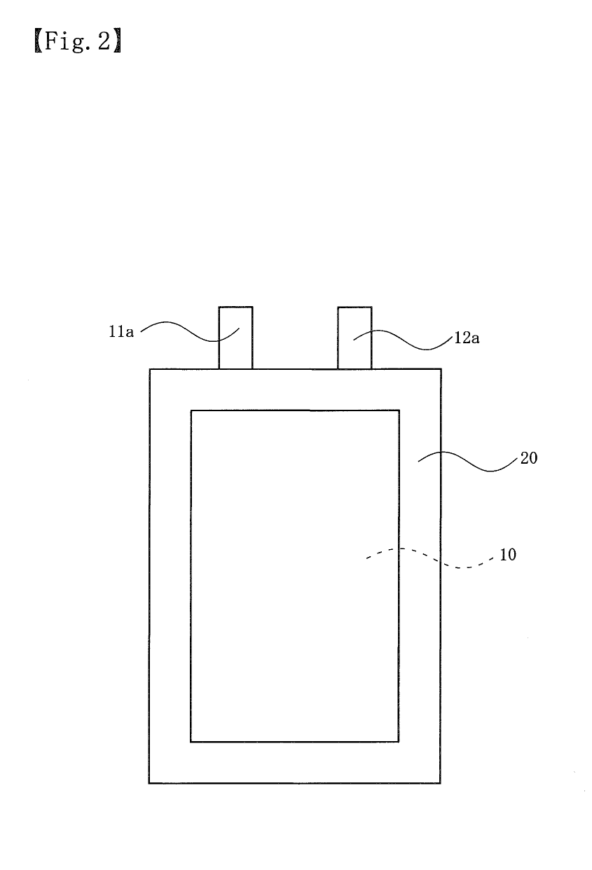

The FIG. 2 is a schematic plain view of a non-aqueous electrolyte secondary battery fabricated for Examples 1 to 5 and Comparative Examples 1 to 5 of the present invention.

### DETAILED DESCRIPTION OF THE PREFERRED EMBODIMENTS

Hereinbelow, preferred embodiments of a non-aqueous electrolyte secondary battery are described in further detail. It should be construed, however, that the non-aqueous electrolyte secondary battery according to the present invention is not limited to the following preferred embodiments thereof, but various changes and modifications are possible unless such changes and variations depart from the scope of the invention as defined by the appended claims.

According to the non-aqueous electrolyte secondary battery of the present invention, in using the first material of the graphite material and the second material of the complex in which graphite material and silicon or silicon composite are coated with amorphous carbon material as the negative electrode active material, if the amount of silicon or silicon composite in the negative electrode active material is too large, volume variation during charging/discharging becomes large, deteriorating charge-discharge cycle characteristics of the non-aqueous electrolyte secondary battery. Therefore, it is preferable that the amount of silicon or silicon composite in the negative electrode active material be less than 20 weight %.

Further, if the amount of the second material of the complex in which graphite material and silicon or silicon composite are coated with amorphous carbon material in the negative electrode active material is too large, the non-aqueous electrolyte is decomposed on the surface of the second material of the complex and the charge-discharge cycle characteristics is deteriorated. Therefore, it is preferable that the amount of the second material in the negative electrode active material be 20 weight % or less.

A graphite powder having excellent charge-discharge characteristics is preferably used for the first material and the second material. In particular, it is preferable to use a graphite powder having a lattice spacing d 002 of nm or less determined by X-ray diffraction analysis and a size Lc of crystal particle in the c-axis direction of not less than 30 nm.

As to the complex used for the second material, a complex which is a graphite material attaching silicon or silicon composite to its surface and being coated with amorphous carbon material may be used.

In preparation of the negative electrode using the negative electrode active material, a negative electrode mixture containing the negative electrode active material, a binder and others is applied to the surface of a negative electrode current collector.

Here, as a material used for the negative electrode current collector, any conductive material having high reduction-resistance may be used. Examples of usable material include copper, nickel, and an alloy containing copper and nickel.

In the non-aqueous electrolyte secondary battery according to the present invention, the type of the positive electrode active material to be used for the positive electrode is not particularly limited. If an electric potential is high and storage/release of lithium ion is possible, any known positive electrode active material that has conventionally been used may be used. Examples of usable positive electrode active material include lithium-containing transition metal oxide, metal oxides, other oxides, and other sulfides. Further, examples of usable lithium-containing transition metal oxide include lithium-cobalt multiple oxide such as LiCoO₂, lithium-nickel multiple oxide such as LiNiO₂, lithium-manganese multiple oxide such as LiMn₂O₄ and LiMnO₂, lithium-nickel-cobalt multiple oxide such as LiNi₁₋ₓCoₓO₂ (0<x<1), lithium-manganese-cobalt multiple oxide such as LiMn₁₋ₓCoₓO₂ (0<x<1), lithium-nickel-cobalt-manganese multiple oxide such as LiNiₓCo_{y}Mn_{z}O₂ (x+y+z=1), and lithium-nickel-cobalt-aluminum multiple oxide such as LiNiₓCO_{y}Al_{z}O₂(x+y+z=1). Further, examples of metal oxides include manganese oxide such as MnO₂, and vanadium oxide such as V₂O₅.

In preparation of the positive electrode using the positive electrode active material, it may be possible that a positive electrode mixture containing a conductive agent, a binder and others is applied to the surface of a positive electrode current collector.

Here, as a material for the positive electrode current collector, any conductive material having high acid-resistance may be used. Examples of usable material include aluminum, stainless steel, and titanium.

Examples of usable conductive agent include acetylene black, graphite and carbon black. As the binder, for example, polyvinylidene fluoride, polytetrafluoroethylene, EPDM, SBR, NBR and fluoride rubber may be used.

As to the non-aqueous electrolyte of the non-aqueous electrolyte secondary battery according to the present invention, any non-aqueous electrolyte containing a solute dissolved in a non-aqueous solvent that has been conventionally used may be used.

According to the present invention, the type of the non-aqueous solvent is not particularly limited and any non-aqueous solvent that has been generally used may be used. Example of usable solvent include a mixed solvent in which a cyclic carbonate such as ethylene carbonate, propylene carbonate and butylene carbonate and a chained carbonate such as dimethyl carbonate, ethyl methyl carbonate and diethyl carbonate are mixed. Alternatively, as the non-aqueous solvent, a mixed solvent in which cyclic carbonate and ether solvent such as 1-2-dimethoxyethane and 1-2-diethoxyethane are mixed may be employed.

According to the present invention, the type of the solute is not particularly limited and any solute that has been generally used may be used. Examples of the usable solute include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAₛF₆, LiClO₄, Li₂B₁₀Cl₁₀, Li₂B₁₂Cl₁₂, which may be used either alone or in combination.

Examples of cyclic carbonic acid ester derivative having fluoride atom added to the non-aqueous electrolyte include 4-fluoro-1,3-dioxolan-2-one, 4-difluoro-1,3-dioxolan-2-one, 4,5-difluoro-1,3-dioxolan-2-one, 4-(fluoromethyl)-1,3-dioxolan-2-one, and 4-(trifluoromethyl)-1,3-dioxolan-2-one. Preferably, 4-difluoro-1,3-dioxolan-2-one may be used.

In adding the cyclic carbonic acid ester derivative having fluoride atom to the non-aqueous electrolyte, if the additional amount is less than 0.1 weight %, a sufficient improvement in charge-discharge cycle characteristics of the non-aqueous electrolyte secondary battery can not be attained. On the other hand, if the additional amount is 30 weight % or more, decomposition of cyclic carbonic acid ester derivative having fluoride atom resulting from a reaction between the negative electrode active material occurs and a battery expansion is easily caused in the case of preservation of the non-aqueous electrolyte secondary battery in charging condition under high temperature environments. Therefore, it is preferable that the amount of cyclic carbonic acid ester derivative having fluoride atom to be added to the non-aqueous electrolyte be within the range of from not less than 0.1 weight % to less than 30 weight %.

As the sulfur-containing composite having cyclic structure to be added to the non-aqueous electrolyte, for example, 1,3-propane sultone, sulfolane, 1,3-propene sultone, 1,4-butane sultone, and 1,4-thioxane may be used. In particular, sulfur-containing composite with cyclic structure having sulfonyl group (—SO₂—) such as 1,3-propane sultone, sulfolane, 1,3-propene sultone and 1,4-butane sultone contributes to form more stable film on the negative electrode active material and therefore the use thereof is preferable.

In adding the sulfur-containing composite having cyclic structure to the non-aqueous electrolyte, if the additional amount is less than 0.1 weight %, the reaction between the cyclic carbonic acid ester derivative having fluoride atom and the negative electrode active material is hardly suppressed and the battery expansion is easily caused in the case of preservation of the non-aqueous electrolyte secondary battery in charging condition under high temperature environments. On the other hand, if the additional amount is 30 weight % or more, initial charge-discharge efficiency is greatly decreased and a non-aqueous electrolyte secondary battery with high capacity can not be obtained. Therefore, it is preferable that the amount of the sulfur-containing composite having cyclic structure to be added to the non-aqueous electrolyte be within the range of from not less than 0.1 weight % to less than 30 weight %.

Hereinbelow, examples will be specifically described of the non-aqueous electrolyte secondary battery according to the present invention, and it will be demonstrated by the comparison with comparative examples that the non-aqueous electrolyte secondary batteries in the examples are capable of preventing a battery expansion in the case of preservation in charging condition under high temperature environments, and improving charge-discharge cycle characteristics.

### EXAMPLE 1

In Example 1, a non-aqueous electrolyte secondary battery was fabricated using a positive electrode, a negative electrode, and a non-aqueous electrolyte that were prepared in the following manner.

### Preparation of Positive Electrode

A positive electrode was prepared as follows. Li₂CO₃ and CO₃O₄ were mixed using Ishikawa-style automated mortar in a manner to provide mol ratio of 1:1 between Li and Co. Then, the resultant mixture were heat-treated at 850° C. for 20 hours and pulverized to obtain lithium-cobalt multiple oxide of LiCoO₂ as a positive electrode active material.

Then, the positive electrode active material, carbon as a conductive agent, and polyvinylidene fluoride as a binder were mixed at weight ratio of 95:2.5:2.5, and further, N-methyl-2-pyrrolidone as dispersion medium was admixed to prepare positive electrode mixture slurry.

Next, the positive electrode mixture slurry was applied to both sides of a positive electrode current collector made of aluminum foil, was dried and was rolled to prepare a positive electrode. Thereafter, a positive electrode current collector tab was attached to the positive electrode. As to the positive electrode prepared as above, a filling density of the positive electrode mixture was 3.60 g/cm³.

### Preparation of Negative Electrode

A negative electrode was fabricated as follows. After silicon material was wet-pulverized to prepare slurry, graphite and carbon pitch were admixed. Then, the resultant mixture was carbonized and classified, and carbon pitch was further added for coating and was further carbonized. Thus, a second material of a composite in which graphite and silicon were coated with amorphous carbon material was obtained. The amount of silicon contained in the composite was 18 weight %.

Next, a negative electrode active material was obtained by mixing graphite of the first material with the composite of the second material at weight ratio of 83:17. As the above-noted graphite, graphite having a lattice plane spacing d 002 of 0.3355 nm determined by X-ray diffraction analysis, and a crystal particle size in the C-axis Lc of 116.1 nm was used. The amount of silicon contained in the negative electrode active material was 3 weight %.

Then, the negative electrode active material and styrene-butadiene rubber as a binder were admixed to an aqueous containing carboxymethylcellose as a viscosity improver dissolved in water. The weight ratio of the negative electrode active material, the binder and viscosity improver should be 97.5:1.5:1.0. Then, the resultant mixture was kneaded to prepare negative electrode mixture slurry.

Next, the negative electrode mixture slurry was applied to both sides of a negative electrode current collector made of copper foil, was dried and was rolled to prepare a negative electrode. Thereafter, a negative electrode current collector tab was attached to the negative electrode. As to the negative electrode prepared as above, a filling density of the negative electrode mixture was 1.60 g/cm³.

### Preparation of Non-Aqueous Electrolyte

A non-aqueous electrolyte was prepared as follows. First, an electrolyte was prepared by dissolving hexafluorophosphate LiPF₆ as a solute at a concentration of 1 mol/l in a mixed solvent in which ethylene carbonate and ethyl methyl carbonate were mixed at volume ratio of 3:7. Next, 2.0 weight % of vinylene carbonate VC, 10.0 weight % of 4-fluoro-1,3-dioxolan-2-one of cyclic carbonic acid ester derivative having fluoride atom, and 2.0 weight % of 1,3-propane sultone of sulfur-containing composite with cyclic structure having sulfonyl group were added to the electrolyte. Thus, the non-aqueous electrolyte was obtained.

Then, the non-aqueous electrolyte secondary battery of Example 1 was fabricated in the following manner. As illustrated in FIGS. 1 (A) and (B), a positive electrode 11 and a negative electrode 12 were spirally coiled with a separator 3 of fine porous film made of polypropylene interposed therebetween, and these were pressed to form a flat electrode 10. Thereafter, a positive electrode current collector tab 11a attached to the positive electrode 11 and a negative electrode current collector tab 12b attached to the negative electrode 12 were thrust out from the flat electrode 10.

Next, as illustrated in FIG. 2, the flat electrode 10 was accommodated in a battery can 20 made of aluminum laminated film and the non-aqueous electrolyte was poured into the battery can 20. Then, an open area of the battery can 20 was sealed so that the positive electrode current collector tab 11a attached to the positive electrode 11 and the negative electrode current collector tab 12b attached to the negative electrode 12 were taken outside. Thus, a non-aqueous electrolyte secondary battery which was 6.2 cm long, 3.5 cm wide and 3.6 mm thickness was obtained.

### EXAMPLE 2

In Example 2, the same procedure as in Example 1 was used to fabricate a non-aqueous electrolyte secondary battery, except that, instead of 1,3-propane sultone, 2 weight % of sulfolane of the sulfur-containing composite with cyclic structure having sulfonyl group was added to the non-aqueous electrolyte.

### EXAMPLE 3

In Example 3, the same procedure as in Example 1 was used to fabricate a non-aqueous electrolyte secondary battery, except that, instead of 1,3-propane sultone, 2 weight % of 1,3-propene sultone of the sulfur-containing composite with cyclic structure having sulfonyl group was added to the non-aqueous electrolyte.

### EXAMPLE 4

In Example 4, the same procedure as in Example 1 was used to fabricate a non-aqueous electrolyte secondary battery, except that, instead of 1,3-propane sultone, 2 weight % of 1,4-butane sultone of the sulfur-containing composite with cyclic structure having sulfonyl group was added to the non-aqueous electrolyte.

### EXAMPLE 5

In Example 5, the same procedure as in Example 1 was used to fabricate a non-aqueous electrolyte secondary battery, except that, instead of 1,3-propane sultone, 2 weight % of 1,4-thioxane of the sulfur-containing composite with cyclic structure not having sulfonyl group was added to the non-aqueous electrolyte.

### COMPARATIVE EXAMPLE 1

In Comparative Example 1, the same procedure as in Example 1 was used to fabricate a non-aqueous electrolyte secondary battery, except that 1,3-propane sultone of the sulfur-containing composite with cyclic structure having sulfonyl group was not added to the non-aqueous electrolyte.

### COMPARATIVE EXAMPLE 2

In Comparative Example 2, the same procedure as in Example 1 was used to fabricate a non-aqueous electrolyte secondary battery, except that 4-fluoro-1,3-dioxolan-2-one of cyclic carbonic acid ester derivative having fluoride atom and 1,3-propane sultone of the sulfur-containing composite with cyclic structure having sulfonyl group were not added to the non-aqueous electrolyte.

### COMPARATIVE EXAMPLE 3

Comparative Example 3 used the same second material of the composite in which graphite and silicon were coated with amorphous carbon material as Example 1, except that the amount of silicon contained was 8 weight %. Further, in Comparative Example 3, the same first material of graphite as Example 1 was mixed with the foregoing second material of the composite at weight ratio of 77:23 to prepare a negative electrode active material.

Further, in Comparative Example 3, in preparation of the non-aqueous electrolyte of Example 1, 1,3-propane sultone of the sulfur-containing composite with cyclic structure having sulfonyl group was not added.

Except for the above, a non-aqueous electrolyte secondary battery of Comparative Example 3 was fabricated in the same manner as in Example 1. Here, the amount of silicon contained in the negative electrode active material was 2 weight %.

### COMPARATIVE EXAMPLE 4

Comparative Example 4 used the same second material of the composite in which graphite and silicon were coated with amorphous carbon material as Example 1, except that the amount of silicon contained was 4 weight %. Further, in Comparative Example 4, the same first material of graphite as Example 1 was mixed with the foregoing second material of the composite at weight ratio of 45:55 to prepare a negative electrode active material.

Further, in Comparative Example 4, in preparation of the non-aqueous electrolyte of Example 1, 1,3-propane sultone of the sulfur-containing composite with cyclic structure having sulfonyl group was not added.

Except for the above, a non-aqueous electrolyte secondary battery of Comparative Example 4 was fabricated in the same manner as in Example 1. Here, the amount of silicon contained in the negative electrode active material was 2 weight %.

### COMPARATIVE EXAMPLE 5

In Comparative Example 5, a negative electrode prepared as follows was used instead of the negative electrode of Example 1. Further, in Comparative Example 5, in the preparation of the non-aqueous electrolyte of Example 1, 1,3-propane sultone of the sulfur-containing composite with cyclic structure having sulfonyl group was not added. Except for the above, a non-aqueous electrolyte secondary battery of Comparative Example 5 was fabricated in the same manner as in Example 1.

In comparative Example 5, the negative electrode was fabricated as follows. Tin, cobalt, titanium and indium were mixed at atom concentration of 45:45:9:1 and melted, then, an alloy of these elements was prepared by rapid quenching method.

Then, 78 parts by weight of the alloy was mixed with 22 parts by weight of acetylene black of carbon material, and the mixture was treated by a mechanical alloying treatment using a planetary ball mill in argon atmosphere for 15 hours to prepare a complex alloy particle. After that, the complex alloy particle was taken out into air, and coarse particle were removed therefrom through a sieve having 150 μm mesh aperture.

Then, the complex alloy particle after removing the coarse particle therefrom as described above was used instead of the second material of the composite.

Further, as the first material, scale-shaped artificial graphite having a lattice plane spacing d 002 of 0.336 nm determined by X-ray diffraction analysis, a crystal particle size in the C-axis Lc of 40 nm, and particle average diameter of 20 μm was used.

Then, a negative electrode active material was prepared by mixing the artificial graphite of the first material and the complex alloy particle of the second material at weight ratio of 6:4.

Next, 98.4 parts by weight of the negative electrode active material, 1.6 parts by weight of polyvinylidene fluoride (PVdf) having intrinsic density of 1.78 g/cm³ as binder, and N-methyl 2-pyrrolidone as solvent were mixed together to prepare negative electrode mixture slurry. The prepared negative electrode mixture slurry was applied to both sides of a negative electrode current collector made of copper foil and was dried. Then, the resultant material was rolled to form a negative electrode and a negative electrode current collector tab was attached thereto. As to the negative electrode, filing density of the negative electrode mixture was 2.90 g/cm³.

Then, each non-aqueous electrolyte secondary battery of Example 1 and Comparative Examples 1 to 4 was charged at a constant current of 800 mA until a battery voltage became 4.2 V under room temperature environments. Thereafter, the forgoing each non-aqueous electrolyte secondary battery was further charged at a constant voltage of 4.2 V until an electric current value became 40 mA, and was discharged at the constant current of 800 mA until the battery voltage reached 2.75 V.

Then, the above charge-discharge cycle was repeated to obtain the number of cycles, cycle life, for each battery until the discharge capacity of each battery was lowered to 60% of a discharge capacity at the first cycle. The results are shown in Table 1 below. As to the Table below, 4-fluoro-1,3-dioxolan-2-one of cyclic carbonic acid ester derivative having fluoride atom is shortened as FEC.

TABLE 1

| | Weight ratio | Additives to Non-aqueous | | |
|---|---|---|---|---|
| | of second | electrolyte (Weight ratio) | | |
| | material in | cyclic carbonic | sulfur- | |
| | negative | acid ester | containing | Cycle |
| | electrode | derivative | composite | life |
| | active | having | having | (Number |
| | material | fluoride atom | cyclic structure | of cycles) |
| Example 1 | 17 wt % | FEC | 1,3-propane | 500 |
| | | (10.0 wt %) | sultone | |
| | | | (2.0 wt %) | |
| Comp. Ex. 1 | 17 wt % | FEC | — | 471 |
| | | (10.0 wt %) | | |
| Comp. Ex. 2 | 17 wt % | — | — | 111 |
| Comp. Ex. 3 | 23 wt % | FEC | — | 302 |
| | | (10.0 wt %) | | |
| Comp. Ex. 4 | 55 wt % | FEC | — | 180 |
| | | (10.0 wt %) | | |

The results demonstrate that the non-aqueous electrolyte secondary batteries of Example 1 and Comparative Examples 1, 3 and 4, which used the non-aqueous electrolyte adding cyclic carbonic acid ester derivative having fluoride atom, exhibited an improvement in cycle life compared with the non-aqueous electrolyte secondary battery of Comparative Example 2 which used the non-aqueous electrolyte not adding cyclic carbonic acid ester derivative having fluoride atom.

The results demonstrate that the non-aqueous electrolyte secondary battery of Example 1 which used the non-aqueous electrolyte adding cyclic carbonic acid ester derivative having fluoride atom and sulfur-containing composite having cyclic structure, exhibited a remarkable improvement in cycle life compared with the non-aqueous electrolyte secondary batteries of Comparative Examples 1, 3 and 4 which used the non-aqueous electrolyte not adding sulfur-containing composite having cyclic structure.

As to the amount of the second material of the complex in which graphite and silicon were coated with amorphous carbon material, the non-aqueous electrolyte secondary battery of Comparative Example 1 using the negative electrode active material wherein the amount of the second material of the complex was 20 weight % or less, exhibited a remarkable improvement in cycle life, compared with the non-aqueous electrolyte secondary batteries of Comparative Examples 3 and 4 using the negative electrode active material wherein the amount of the second material of the complex was more than 20 weight %.

This result suggests that it is preferable that the amount of the second material of the complex in which graphite and silicon were coated with amorphous carbon material be 20 weight % or less.

Next, each non-aqueous electrolyte secondary battery of Examples 1 to 5 and Comparative Examples 1 and 5 was charged at the constant current of 800 mA until the battery voltage became 4.2 V under room temperature environments. Thereafter, the forgoing each non-aqueous electrolyte secondary battery was further charged at the constant voltage of 4.2 V until the electric current value became 40 mA, and discharged at the constant current of 800 mA until the battery voltage reached 2.75 V. Thus, the first discharge capacity Qo was obtained.

Next, each non-aqueous electrolyte secondary battery was charged at the constant current of 800 mA until the battery voltage became 4.2 V under room temperature environments. Thereafter, the each non-aqueous electrolyte secondary battery was further charged at the constant voltage of 4.2 V until the electric current value became 40 mA. Thus, a battery thickness in charging condition before preservation of each non-aqueous electrolyte secondary battery was measured.

Next, each non-aqueous electrolyte secondary battery in charging condition was preserved in a thermostatic container at 85° C. for 3 hours. After that, each non-aqueous electrolyte secondary battery was taken out of the thermostatic container and left to be cooled under room temperature environments for 1 hour, and the battery thickness after preservation of each non-aqueous electrolyte secondary battery was measured. Then, an increment of the battery thickness after the preservation to before preservation was determined. The results are shown in Table 2 below.

Further, each non-aqueous electrolyte secondary battery of Examples 1 to 5 and Comparative Examples 1 and 5 after the preservation was discharged at the constant current of 800 mA until the battery voltage became 2.75 V, to measure discharge capacity Qa after the preservation. Then, percentage of capacity retention (%) was obtained according to the following equation. The results are shown in Table 2 below.

percentage of capacity retention (%)=(Qa/Qo)×100

TABLE 2

| | | Additives to Non-aqueous | | | |
|---|---|---|---|---|---|
| | | electrolyte (Proportion) | | | |
| | Type of second | cyclic carbonic | sulfur- | Increment | Percentage |
| | material in | acid ester | containing | of | of capacity |
| | negative electrode | derivative having | composite having | battery | retention |
| | active material | fluoride atom | cyclic structure | thickness | (%) |
| Example 1 | complex | FEC | 1,3-propane | 1.34 mm | 76.1 |
| | | (10.0 wt %) | sultone | | |
| | | | (2.0 wt %) | | |
| Example 2 | complex | FEC | sulfolane | 1.49 mm | 78.9 |
| | | (10.0 wt %) | (2.0 wt %) | | |
| Example 3 | complex | FEC | 1,3-propene | 0.69 mm | 84.9 |
| | | (10.0 wt %) | sultone | | |
| | | | (2.0 wt %) | | |
| Example 4 | complex | FEC | 1,4-butane | 1.37 mm | 78.2 |
| | | (10.0 wt %) | sultone | | |
| | | | (2.0 wt %) | | |
| Example 5 | complex | FEC | 1,4-thioxane | 0.71 mm | 69.9 |
| | | (10.0 wt %) | (2.0 wt %) | | |
| Comp. Ex. 1 | complex | FEC | — | 1.92 mm | 71.8 |
| | | (10.0 wt %) | | | |
| Comp. Ex. 5 | complex | FEC | — | 1.02 mm | 60.3 |
| | alloy | (10.0 wt %) | | | |

The results demonstrate the following. In each of the non-aqueous electrolyte secondary batteries of Examples 1 to 5 using the negative electrode active material containing the second material of the complex in which graphite and silicon were coated with amorphous carbon material, and the non-aqueous electrolyte wherein the cyclic carbonic acid ester derivative having fluoride atom and the sulfur-containing composite having cyclic structure were added, the battery expansion in the case of preservation in charging condition under high temperature environments was restricted, and therefore showed smaller increment of the battery thickness, compared with the non-aqueous electrolyte secondary battery of Comparative Example 1 which used the non-aqueous electrolyte wherein only cyclic carbonic acid ester derivative having fluoride atom was added and the sulfur-containing composite having cyclic structure was not added.

The result also demonstrate that the non-aqueous electrolyte secondary battery of Comparative Example 5 using the second material of the complex alloy particle in the negative electrode active material, although the sulfur-containing composite having cyclic structure was not added to the non-aqueous electrolyte used therein, exhibited small increment of the battery thickness. This result suggest that an effect that the increment of the battery thickness is suppressed in the case of adding the sulfur-containing composite having cyclic structure to the non-aqueous electrolyte is a peculiar effect in the case of using the second material of the complex in which graphite and silicon were coated with amorphous carbon material in the negative electrode active material.

Also, the result demonstrate that each non-aqueous electrolyte secondary battery of Examples 1 to 4 using the sulfur-containing composite with cyclic structure having sulfonyl group, exhibited a remarkable improvement in the percentage of capacity retention and a less decrease in the capacity in the case of preservation in charging condition under high temperature environments, compared with the non-aqueous electrolyte secondary batteries of Example 5 and Comparative Example 1 using the sulfur-containing composite with cyclic structure not having sulfonyl group.

Although the present invention has been fully described by way of examples, it is to be noted that various changes and modification will be apparent to those skilled in the art.

Therefore, unless otherwise such changes and modifications depart from the scope of the present invention, they should be construed as being included therein.

1. A non-aqueous electrolyte secondary battery comprising: a positive electrode containing a positive electrode active material capable of storing and releasing lithium ion; a negative electrode containing a negative electrode active material capable of storing and releasing lithium ion; and a non-aqueous electrolyte; wherein
said negative electrode active material comprises a first material of a graphite material and a second material of a complex in which graphite material and silicon or silicon composite are coated with amorphous carbon material; and wherein cyclic carbonic acid ester derivative having fluoride atom and sulfur-containing composite having cyclic structure are added to said non-aqueous electrolyte.

2. The non-aqueous electrolyte secondary battery according to claim 1, wherein the amount of silicon or silicon composite in the negative electrode active material is less than 20 weight %.

3. The non-aqueous electrolyte secondary battery according to claim 1, wherein the complex is the graphite material attaching silicon or silicon composite to its surface and being coated with amorphous carbon material.

4. The non-aqueous electrolyte secondary battery according to claim 1, wherein said cyclic carbonic acid ester derivative having fluoride atom is 4-fluoro-1,3-dioxolan-2-one.

5. The non-aqueous electrolyte secondary battery according to claim 1, wherein the cyclic carbonic acid ester derivative having fluoride atom is added to the non-aqueous electrolyte in the range of from not less than 0.1 weight % to less than 30 weight %.

6. The non-aqueous electrolyte secondary battery according to claim 1, wherein said sulfur-containing composite with cyclic structure has sulfonyl group.

7. The non-aqueous electrolyte secondary battery according to claim 1, wherein the sulfur-containing composite with cyclic structure is added to the non-aqueous electrolyte in the range of from not less than 0.1 weight % to less than 30 weight %.

8. The non-aqueous electrolyte secondary battery according to claim 1, wherein the amount of the second material in the negative electrode active material is 20 weight % or less.
